(19) United States
(12) Patent Application Publication
(10) Pub. No.: US 2003/0135632 A1
(43) Pub. Date: Jul. 17, 2003

(54) Priority scheduler

(76) Inventors: Sophie Vrzic, Nepean (CA); Mo-Han Fong, L'Orignal (CA); Hang Zhang, Nepean (CA)

Correspondence Address: WITHROW & TERRANOVA, P.L.L.C., P.O. BOX 1287, CARY, NC, 27512, US

(21) Appl. No.: 10/020,833

(22) Filed: Dec. 13, 2001

(51) Int. Cl. G06F 15/16

(52) U.S. Cl. 709/231

(57) ABSTRACT

The present invention provides for a scheduling data for transmission by an access point, such as a base station. The scheduling provides adaptive fairness control, which depends on how close the users are to a minimum data rate requirement. If desired, more emphasis can be placed on fairness when there are users close to the minimum data rate requirement and more emphasis on maximizing throughput when all of the users are far from the required minimum data rate. Scheduling can also guarantee a maximum drop rate for delay-sensitive data, assuming sufficient resources are available, as well as guarantee a minimum data transfer rate for all users by ensuring that users below their minimum requirement have a higher priority than users that exceed their minimum requirement. If there are not enough resources to satisfy each user's minimum data rate due to a failure of the call admission process, then the variance in throughput can be minimized for each class of users. The scheduling can also optimize scheduling parameters for multi-carrier systems by using the number of carriers to determine scheduling parameters for the delay-sensitive users in order to maximize throughput.

### FIELD OF THE INVENTION

The present invention relates to wireless communications, and in particular to scheduling data for transmission from a base station to one or more mobile terminals.

### BACKGROUND OF THE INVENTION

Wireless communication networks that allocate communication resources, such as time or frequency, require a scheduler to select data to be transmitted. When multiple users are vying for these resources, the scheduler must analyze the incoming data and determine the data having the highest priority for transmission. Priority has traditionally been based on maximizing overall system throughput or maintaining a certain Quality of Service (QoS) level to ensure that data is transmitted in a timely fashion. When maximizing throughput, users having better channel conditions are favored over those with worse channel conditions. Thus, the users with the less favorable channel conditions are always given lower priority unless time-sensitive data is discovered.

In wireless systems with adaptive modulation and coding that require fast scheduling, a flexible scheduler is needed that can guarantee each user's QoS while, at the same time, provide some degree of fairness among the different classes of users. In addition to the fairness and QoS requirements, the scheduler should also be able to maximize the system throughput by taking advantage of the different rates that are assigned to the different users.

System capacity is a function of outage criteria, which is defined as the probability that the QoS on a per-user basis is not satisfied. Wireless-Internet services are characterized in general into two categories: delay-sensitive services and non-delay-sensitive services. For delay-sensitive services, delivery of each packet before a maximum specified delay is critical in order to guarantee acceptable QoS. When the delay bound is exceeded, the packet is considered dropped. The delay requirement can range from tens of milliseconds for interactive services to several seconds for streaming services. In certain systems, it is recommended that the probability of a packet drop due to the delay bound being exceeded be less than two percent. For non-delay-sensitive services, guaranteeing a maximum delay for each packet is not necessary; however, end user perceived performance is still important.

There are many problems with existing schedulers in terms of supporting multi-media wireless-internet services. The schedulers are not designed for multi-carrier operation, which makes them unsuitable for multiple carrier—data and voice (MC-DV) environments. Many schedulers prioritize packets based on carrier-to-interference (C/I) ratios. Such schedulers maximize throughput without regard to fairness or minimum throughput requirements and typically schedule delivery for users that are closest to the base station. Schedulers attempting to provide proportional fairness attempt to maximize throughput while at the same time provide some degree of fairness; however, these schedulers are not designed to satisfy the delay requirements of the delay-sensitive users. Another problem with existing proportional fairness schedulers is that they cannot control the degree of fairness. Further, the schedulers fail to address the outage criteria, guarantee minimum data rates, or minimize drop rates for the delay-sensitive users.

Accordingly, there is a need for a scheduling technique capable of 1) guaranteeing the per-packet delay bound for delay-sensitive services, 2) guaranteeing a required minimum data rate for a particular service or user, and 3) providing adaptive fairness control. There is a further need for a technique with these capabilities that can optimize multi-carrier and multi-user diversity in order to maximize overall system throughput.

### SUMMARY OF THE INVENTION

The present invention provides for a scheduling data for transmission by an access point, such as a base station. The scheduling provides adaptive fairness control, which depends on how close the users are to a minimum data rate requirement. If desired, more emphasis can be placed on fairness when there are users close to the minimum data rate requirement and more emphasis on maximizing throughput when all of the users are far from the required minimum data rate. Scheduling can also guarantee a maximum drop rate for delay-sensitive data, assuming sufficient resources are available, as well as guarantee a minimum data transfer rate for all users by ensuring that users below their minimum requirement have a higher priority than users that exceed their minimum requirement. If there are not enough resources to satisfy each user's minimum data rate due to a failure of the call admission process, then the variance in throughput can be minimized for each class of users. The scheduling can also optimize scheduling parameters for multi-carrier systems by using the number of carriers to determine scheduling parameters for the delay-sensitive users in order to maximize throughput.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block representation of a wireless communication environment according to one embodiment of the present invention.

FIG. 2 is a flow diagram according to one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

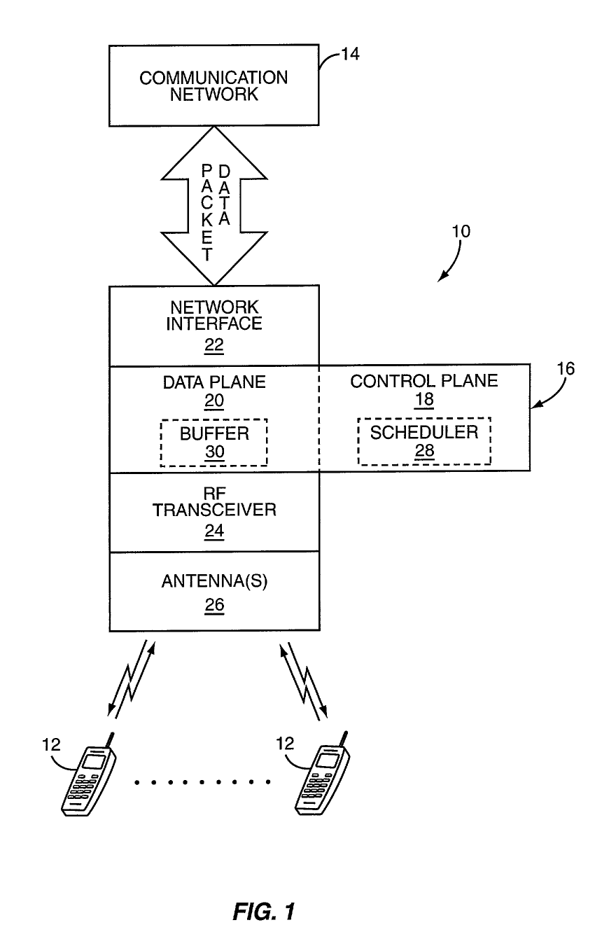

With reference to FIG. 1, wireless networks use access points, such as base stations 10, to facilitate communications with access terminals, such as mobile terminals 12, within a select coverage area, or cell. Respective groups of base stations 10 are supported by a communication network 14, which may include mobile switching centers, a public switched telephone network (PSTN), a packet-switched network, or a combination thereof. The communication network 14 is used to transport packets to and from the base station 10. The packets may be communicated in a direct packet-switched manner or on top of a circuit-switched platform. The manner in which the packets are communicated to the base station 10 is not critical to the invention.

During downlink communications from the base station 10 to select mobile terminals 12, the base station 10 must determine the manner and order in which to transmit the data received in the packets from the communication network 14 to the mobile terminals 12. In multiple carrier systems, the base station 10 will also determine the carrier, or channel, on which to deliver the packets. Accordingly, the base station 10 will include a control system 16 having control plane 18 controlling the flow of data through a data plane 20. For communicating with the mobile terminals 12, the data plane 20 will process packets received from the communication network 14 via a network interface 22 under the control of the control plane 18. The packets are processed into units, which are delivered to radio frequency (RF) transceiver circuitry 24 for transmission. For the sake of clarity, the term “packet” refers to packetized data, which is received by the base station 10 from the communication network 14. The term “unit” refers to packetized data that is transmitted from the base station 10 to the mobile terminals 12. A unit may include all or any part of one or more packets. Although units may directly correspond to packets, units are preferably a given size wherein packets may vary in size from one packet to another. The units may include voice, video, or traditional data.

The forward link from the base station 10 to the mobile terminal 12 will include one or more channels, which are divided into defined time slots. The RF transceiver circuitry 24 is configured to modulate a given unit as dictated by the control plane 18 and transmit the modulated unit via one or more antennas 26 during a single time slot. The RF transceiver circuitry 24 is preferably configured to implement different modulation and coding techniques and speeds based on channel conditions, the capabilities of the mobile terminals 12, or required transmission standards. As noted, the RF transceiver circuitry 24 may transmit units over a number of carriers, or channels. Those skilled in the art will recognize the various possible modulation techniques and that multiple units may be transmitted in a given time slot.

The control plane 18 includes a scheduler 28, which is configured to prioritize and control the delivery order of units to the mobile terminals 12 based on parameters detailed further below. During operation, packets for any number of mobile terminals 12 are received and stored in a buffer 30 associated with the data plane 20. The buffer 30 is segregated into multiple queues, each associated with a given mobile terminal 12. If the packets do not directly correspond to units, the incoming packets are processed into the desired units. The units are stored in the respective queues in the order in which they are received. Preferably, the queues use a first-in-first-out (FIFO) configuration.

In operation, the scheduler 28 can provide a guaranteed minimum drop rate for delay-sensitive data, assuming sufficient resources are available. The Quality of Service (QoS) target for delay-sensitive users is measured in terms of the percentage of units that are dropped due to the delay bound being exceeded. For real-time services such as streaming video, there is a requirement that no more than two percent of each user's packets be dropped. When enough resources are available, the scheduler 28 can guarantee that no units are dropped. Furthermore, this QoS target can be guaranteed in such a way that it minimizes the impact on throughput. The QoS target is guaranteed by ensuring that units near their individual delay bound have a higher priority than all units from non-real-time services. The start time at which these units have a higher priority is optimized in order to guarantee the drop rate and to maximize throughput. The start time is calculated based on the number of delay-sensitive users, the maximum number of slots needed for transmission, the maximum number of transmission attempts, and the number of carriers. The relative priority among the time-sensitive units is inversely proportional to how close they are to their delay bound.

The scheduler 28 can also guarantee a minimum data transfer rate for all users by ensuring that users below their minimum requirement have a higher priority than users that exceed their minimum requirement. If there are not enough resources to satisfy each user's minimum data rate due to a failure of the call admission process, then the variance in throughput can be minimized for each class of users.

The scheduler 28 can provide adaptive fairness control, which depends on how close the users are to the minimum data rate requirement. This allows for more emphasis to be placed on fairness when there are users close to the minimum data rate requirement and more emphasis on maximizing throughput when all of the users are far from the required minimum data rate. The scheduler 28 can also optimize scheduling parameters for multi-carrier systems, using the number of carriers to determine scheduling parameters for the delay-sensitive users in order to maximize throughput.

In general, the scheduler assigns a throughput and fairness priority and a delay priority to each unit in the queue. The throughput and fairness priority controls the degree of fairness and ensures the minimum bit rate requirement, while the delay priority ensures that the delay bound is satisfied. The packet with the highest sum of the two priorities is then scheduled for transmission to the required user, on one or more of the selected carriers. In one embodiment of the present invention, the scheduler 28 is configured to control scheduling for multiple channels and facilitates scheduling based on:

channel conditions, such as a carrier-to-interference (C/I) value for each of the carriers,

the average data throughput for each user,

the minimum required throughput for user,

the maximum queuing delay for each of the delay-sensitive users, and

the number of carriers.

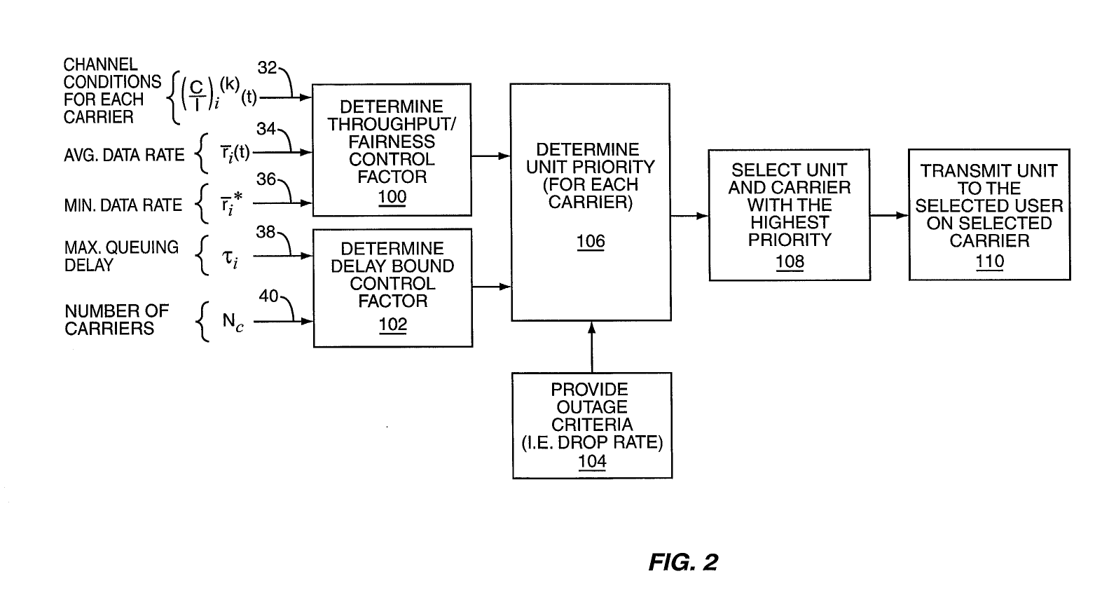

The basic flow for scheduling is illustrated in FIG. 2. Channel conditions 32, such as the C/I ratio value, for each user and each carrier, (C/1)ᵢ^{(k)}(t), are used to maximize throughput, while the average data rate 34, \overline{r}ᵢ(t), and the required minimum data rate 36, \overline{r}ᵢ^{*}, are used to control fairness and to guarantee the minimum data rate for each user. Accordingly, these factors are processed to determine a throughput/fairness control factor (step 100). The maximum queuing delay 38, τᵢ, and the number of carriers 40, N_{c}, are used to guarantee the delay bound for each user in delay-sensitive transfers and are processed to determine a delay bound factor (step 102).

A channel condition represents the quality of the transmission channel from the base station 10 to the mobile terminals 12. The throughput rates may be a function of actual data throughput, channel conditions, or a combination thereof. Channel conditions may vary continuously and may be determined using any number of techniques. For example, (C/I) ratios, which represent a measure of signal power to interference power, may be fed back to the base station 10 from the mobile terminals 12. The scheduler 28 can continuously track channel conditions as well as a current channel condition for each mobile terminal 12. Similarly, the scheduler 28 can keep track of an average and current rate of data throughput for each of the mobile terminals 12. The delay bound typically defines the time in which a unit or series of units must be delivered. Scheduling may be optimized to account for the units' delay bounds and the amount of data to transmit.

In general, the scheduler 28 assigns a priority to each unit in the queue using the equation

Pᵢⱼ(tₙ)=Fₗ(tₙ)+D_{y}(tₙ),

where Pᵢⱼ is the priority for packet j of application i. In the above equation, the variable Fₗ(tₙ) corresponds to the throughput and fairness requirements, while the variable Dᵢⱼ(tₙ) corresponds to the delay requirement. The throughput/fairness component Fₗ(tₙ) ensures that the required minimum bit rate is satisfied for each application while, at the same time, providing control for maximizing the overall system throughput.

The throughput and fairness component Fₗ(tₙ) includes two components. The first component maximizes throughput by giving a higher priority to a user with a higher selected data rate, while the second component guarantees the minimum throughput and controls the degree of fairness by comparing the average throughput to the minimum required throughput. The equation can be written as

$${F}_{i} ( {t}_{n} ) = f ( {r}_{i} ( {t}_{n} ) ) \cdot g ( {\overline{r}}_{i} ( {t}_{n} ) ) , \\ where$$

$$f ( {r}_{i} ( {t}_{n} ) ) = [ \frac{{r}_{i} ( {t}_{n} )}{{r}_{max}} ]$$

$$and$$

$$g ( {\overline{r}}_{i} ( {t}_{n} ) ) = \{ \begin{matrix}2 - \frac{{\overline{r}}_{i} ( {t}_{n} )}{{\overline{r}}_{i}^{*}} , if {\overline{r}}_{i} ( {t}_{n} ) \leq {\overline{r}}_{i}^{*} \\ {a}^{( {\overline{r}}_{i} ( {t}_{n} ) - {\overline{r}}_{i}^{*}} , otherwise\end{matrix} .$$

In the above equations, rₗ(tₙ) is the selected data rate at time tₙ, \overline{r}ₗ(tₙ) is the average data rate at time tₙ, \overline{r}ᵢ^{*} is the required minimum throughput rate and rₘₐₓ is the maximum possible data rate that can be selected.

The value for the parameter a, used in the equation for g, depends on how close the users are to their individual required minimum throughput rate. The parameter a can be represented by

$$a = h ( {min}_{i} \{ {\overline{r}}_{i} ( {t}_{n} ) - {\overline{r}}_{i}^{*} \} ) ,$$

where the minimum is taken over all the users in the sector and h is an increasing function. If there is at least one user with a data rate less than the required minimum, then the value for a is set to zero.

The fairness and throughput component Fₗ(tₙ) of scheduler 28 can have the following properties:

throughput increases as the parameter a increases,

the degree of fairness increases as the parameter a decreases,

if a is equal to one then the scheduler is equivalent to a maximum C/I scheduler,

each user's minimum data rate is guaranteed if there are enough resources,

if there are not enough resources to satisfy each user's minimum data rate then the variance in the throughput will be minimized for each class of users and if

\overline{r}₁=k\overline{r}₁^{*}

then

\overline{r}₂=k\overline{r}₂^{*}; and

the equation Fₗ(tₙ) is bounded, 0≦F₁(tₙ)≦Fₘₐₓ.

Accordingly, the scheduler 28 can guarantee each user's minimum required data rate, while providing emphasis on either fairness or on maximizing throughput. The degree of fairness is set adaptively, and depends on how close the users are to their individual minimum data rate requirements. If there are not enough resources to satisfy each user's minimum data rate requirement, the variance in throughput will be minimized for each class of users.

The delay component Dᵢⱼ(tₙ) of the scheduler 28 guarantees the delay bound by assigning a start time to each delay-sensitive unit, which represents the first time the unit will be given a higher priority than any of the non-delay sensitive units. Among the delay-sensitive units with a scheduling time larger than its start time, the scheduler 28 gives a higher priority to those units closer to its delay bound. The delay component Dᵢⱼ(tₙ) of the priority equation can be represented by the following equation

$${D}_{ij} ( {t}_{n} ) = \{ \begin{matrix}\frac{( {t}_{n} - {t}_{min , ij} )}{{t}_{max , ij} - {t}_{min , ij}} + {F}_{max} , if {t}_{n} \geq {t}_{min , ij} \\ 0 , otherwise\end{matrix} ,$$

where t_{min,ij} is the first time slot for which user i has a higher priority than any of the non-delay sensitive users; t_{min,ij} is the latest time that the j^{th} unit for user i can be sent; and Fₘₐₓ is the maximum value of the fairness priority equation. The value for t_{min,ij} can depend on the number of slots needed to successfully transmit the unit, the total number of delay-sensitive users in the system, the maximum number of transmission attempts, and the number of carriers. It can be calculated using the following equation:

$${t}_{min , ij} = {t}_{max , ij} - \frac{1}{{N}_{c}} {\sum }_{k = 1}^{{N}_{d}} ( {N}_{s , k} \cdot {N}_{max} \cdot E [ {N}_{p , k} ] ) - M .$$

The term N_{s,k} is the maximum number of slots that are needed to transmit a unit from user k, Nₘₐₓ is the maximum number of transmission attempts, E└N_{,k}┘ is the expected number of packets in the queue for user k, N_{d} is the number of delay sensitive users and N_{c} is the number of carriers. The parameter M is provided to control the maximum drop rate (step 104) and can initially be set to zero. The parameter M can then be either increased or decreased in order to control the drop rate to the required maximum.

For a multi-carrier system, in order to maximize the system throughput while guaranteeing the required minimum data rate, the priority equation, Pᵢⱼ, is evaluated for each carrier (step 106). Next, the first unit to be transmitted is preferably selected by maximizing the priority across all carriers (step 108). Prioritization can be represented by the following equation:

$${max}_{p , k} \{ {P}_{p}^{( k )} \} ,$$

where Pₚ^{(k)} is the priority for unit p on carrier k. Once selected, the unit having the highest priority is transmitted using the appropriate carrier giving rise to the priority rating (step 110). Then, the next unit is selected by maximizing the priority equation across the remaining carriers and units. This is given by

$${max}_{{p \neq {p}_{1}}_{k \neq {c}_{1}}} \{ {P}_{p}^{( k )} \} .$$

This process continues until units have been scheduled on all the carriers and transmitted accordingly.

In essence, the novel scheduler 28 of the present invention can provide a guaranteed minimum drop rate for delay-sensitive data, assuming sufficient resources are available, as well as guarantee a minimum data transfer rate for all users by ensuring that users below their minimum requirement have a higher priority than users that exceed their minimum requirement. If there are not enough resources to satisfy each user's minimum data rate due to a failure of the call admission process, then the variance in throughput can be minimized for each class of users. The scheduler 28 can also provide adaptive fairness control, which depends on how close the users are to the minimum data rate requirement. If desired, more emphasis can be placed on fairness when there are users close to the minimum data rate requirement and more emphasis placed on maximizing throughput when all of the users are far from the required minimum data rate. The scheduler can also optimize scheduling parameters for multi-carrier systems by using the number of carriers to determine scheduling parameters for the delay-sensitive users in order to maximize throughput.

These aspects of the invention can be implemented using alternative equations and relationships than those described in detail above. Those skilled in the art will recognize improvements and modifications to the preferred embodiments of the present invention. All such improvements and modifications are considered within the scope of the concepts disclosed herein and the claims that follow.

What is claimed is:

1. An access point for scheduling delivery of units of data to a plurality of access terminals comprising:
a) a network interface for receiving data from a communication network;
b) a wireless interface for transmitting units of the data to a plurality of access terminals; and
c) a control system associated with the network interface and the wireless interface and adapted to:
i) store the data received over the communication network as units corresponding to the plurality of access terminals;
ii) generate a prioritization factor for each unit of data, the prioritization factor being controlled:
A) in proportion to a required data rate associated with each unit of data,
B) to maintain a minimum desired data rate associated with each unit of data, and
C) to achieve an adaptive fairness objective; and
iii) schedule transmission of each unit of data based on the prioritization factor.

2. The access point of claim 1 wherein the adaptive fairness objective functions to adaptively increase the prioritization factor as an average data rate associated with each unit of data approaches the minimum desired data rate associated with each unit of data.

3. The access point of claim 1 wherein when there are insufficient resources to maintain the minimum desired data rate associated with each unit of data, the control system is further adapted to control the prioritization factor for each unit of data to reduce the variance in data rates associated with the units of data between different users.

4. The access point of claim 1 wherein the adaptive fairness objective is configurable to make overall throughput of the units of data inversely proportional to fairness between different users.

5. The access point of claim 1 wherein select ones of the units of data are time-sensitive and associated with a delay bound and the control system is further adapted to control the prioritization factor for each time-sensitive unit of data in inverse proportion to an amount of time prior to the delay bound associated with each time-sensitive unit of data wherein the time-sensitive units of data are given higher priorities as the delay bounds approach.

6. The access point of claim 5 wherein each time-sensitive unit of data is associated with a start time, which represents a threshold when the prioritization factor for the unit of data is adjusted based on the delay bound.

7. The access point of claim 5 wherein the control system is further adapted to adjust the prioritization factor for each time-sensitive unit of data to control the maximum percentage of the units of data that can be dropped prior to transmission.

8. The access point of claim 1 wherein a plurality of carriers are available to transmit the units of data and the control system is further adapted to generate the prioritization factor for each unit of data for each of the plurality of carriers and schedule the transmission of each unit of data on at least one of the plurality of carriers based on the prioritization factor.

9. The access point of claim 1 wherein:
a) the adaptive fairness objective functions to adaptively increase the prioritization factor as an average data rate associated with each unit of data approaches the minimum desired data rate associated with each unit of data; and
b) select ones of the units of data are time-sensitive and associated with a delay bound and the control system is further adapted to control the prioritization factor for each time-sensitive unit of data in inverse proportion to an amount of time prior to the delay bound associated with each time-sensitive unit of data wherein the time-sensitive units of data are given higher priorities as the delay bounds approach.

10. A method for scheduling delivery of units of data to a plurality of access terminals comprising:
a) storing data received over a communication network as units corresponding to the plurality of access terminals;
b) generating a prioritization factor for each unit of data, the prioritization factor being controlled:
i) in proportion to a required data rate associated with each unit of data,
ii) to maintain a minimum desired data rate associated with each unit of data, and
iii) to achieve an adaptive fairness objective; and
c) scheduling transmission of each unit of data based on the prioritization factor.

11. The method of claim 10 wherein the adaptive fairness objective functions to adaptively increase the prioritization factor as an average data rate associated with each unit of data approaches the minimum desired data rate associated with each unit of data.

12. The method of claim 10 wherein when there are insufficient resources to maintain the minimum desired data rate associated with each unit of data, the method further comprises controlling the prioritization factor for each unit of data to reduce the variance in data rates associated with the units of data between different users.

13. The method of claim 10 wherein the adaptive fairness objective is configurable to make overall throughput of the units of data inversely proportional to fairness between different users.

14. The method of claim 10 wherein select ones of the units of data are time-sensitive and associated with a delay bound and the method further comprises controlling the prioritization factor for each time-sensitive unit of data in inverse proportion to an amount of time prior to the delay bound associated with each time-sensitive unit of data wherein the time-sensitive units of data are given higher priorities as the delay bounds approach.

15. The method of claim 14 wherein each time-sensitive unit of data is associated with a start time, which represents a threshold when the prioritization factor for the unit of data is adjusted based on the delay bound.

16. The method of claim 14 further comprising adjusting the prioritization factor for each time-sensitive unit of data to control the maximum percentage of the units of data that can be dropped prior to transmission.

17. The method of claim 10 wherein a plurality of carriers are available to transmit the units of data, the prioritization factor is generated for each unit of data for each of the plurality of carriers and the transmission of each unit of data is scheduled on at least one of the plurality of carriers based on the prioritization factor.

18. The method of claim 10 wherein:
a) the adaptive fairness objective functions to adaptively increase the prioritization factor as an average data rate associated with each unit of data approaches the minimum desired data rate associated with each unit of data; and
b) select ones of the units of data are time-sensitive and associated with a delay bound and the method further comprises controlling the prioritization factor for each time-sensitive unit of data in inverse proportion to an amount of time prior to the delay bound associated with each time-sensitive unit of data wherein the time-sensitive units of data are given higher priorities as the delay bounds approach.

19. A computer readable medium having software for scheduling transmission of units of data corresponding to a plurality of access terminals, the software comprising instructions to:
a) store data sent from a communication network as units corresponding to the plurality of access terminals;
b) generate a prioritization factor for each unit of data, the prioritization factor being controlled:
i) in proportion to a required data rate associated with each unit of data,
ii) to maintain a minimum desired data rate associated with each unit of data, and
iii) to achieve an adaptive fairness objective; and
c) schedule transmission of each unit of data based on the prioritization factor.

20. The computer readable medium of claim 19 wherein the adaptive fairness objective functions to adaptively increase the prioritization factor as an average data rate associated with each unit of data approaches the minimum desired data rate associated with each unit of data.

21. The computer readable medium of claim 19 wherein when there are insufficient resources to maintain the minimum desired data rate associated with each unit of data, the instructions are further adapted to control the prioritization factor for each unit of data to reduce the variance in data rates associated with the units of data between different users.

22. The computer readable medium of claim 19 wherein the adaptive fairness objective is configurable to make overall throughput of the units of data inversely proportional to fairness between different users.

23. The computer readable medium of claim 19 wherein select ones of the units of data are time-sensitive and associated with a delay bound and the instructions are further adapted to control the prioritization factor for each time-sensitive unit of data in inverse proportion to an amount of time prior to the delay bound associated with each time-sensitive unit of data wherein the time-sensitive units of data are given higher priorities as the delay bounds approach.

24. The computer readable medium of claim 23 wherein each time-sensitive unit of data is associated with a start time, which represents a threshold when the prioritization factor for the unit of data is adjusted based on the delay bound.

25. The computer readable medium of claim 23 wherein the instructions are further adapted to adjust the prioritization factor for each time-sensitive unit of data to control the maximum percentage of the units of data that can be dropped prior to transmission.

26. The computer readable medium of claim 19 wherein a plurality of carriers are available to transmit the units of data and the instructions are further adapted to generate the prioritization factor for each unit of data for each of the plurality of carriers and schedule the transmission of each unit of data on at least one of the plurality of carriers based on the prioritization factor.

27. The computer readable medium of claim 19 wherein:
a) the adaptive fairness objective functions to adaptively increase the prioritization factor as an average data rate associated with each unit of data approaches the minimum desired data rate associated with each unit of data; and
b) select ones of the units of data are time-sensitive and associated with a delay bound and the instructions are further adapted to control the prioritization factor for each time-sensitive unit of data in inverse proportion to an amount of time prior to the delay bound associated with each time-sensitive unit of data wherein the time-sensitive units of data are given higher priorities as the delay bounds approach.

28. A system for scheduling delivery of units of data to a plurality of access terminals comprising:
a) means for storing data received over a communication network as units corresponding to the plurality of access terminals;
b) means for generating a prioritization factor for each unit of data, the prioritization factor being controlled:
i) in proportion to a required data rate associated with each unit of data,
ii) to maintain a minimum desired data rate associated with each unit of data, and
iii) to achieve an adaptive fairness objective; and
c) means for scheduling transmission of each unit of data based on the prioritization factor.
